(19) United States
(12) Patent Application Publication
(10) Pub. No.: US 2022/0318068 A1
(43) Pub. Date: Oct. 6, 2022

(54) METHODS AND SYSTEMS FOR MANAGING A PLURALITY OF CLOUD ASSETS

(71) Applicant: ManTech International Corporation, Herndon, VA (US)

(72) Inventor: Sandeep SHILAWAT, Herndon, VA (US)

(73) Assignee: ManTech International Corporation, Herndon, VA (US)

(21) Appl. No.: 17/658,019

(22) Filed: Apr. 5, 2022

Related U.S. Application Data
(60) Provisional application No. 63/171,158, filed on Apr. 6, 2021.

(51) Int. Cl. G06F 9/50; G06F 8/65

(52) U.S. Cl. CPC G06F 9/5077; G06F 8/65; G06F 9/5072; G06F 2209/508

(57) ABSTRACT

Methods and systems for managing a plurality of cloud assets are disclosed. A method may include receiving first cloud account data from a first cloud service provider; receiving second cloud account data from a second cloud service provider; receiving analyzed content from a first software vendor and a second software vendor, the analyzed content based on the first cloud account data and the second cloud account data; correlating the first account data, the second account data, and the analyzed content; generating a correlated data graphical user interface (GUI) based on the correlating; receiving a cloud account update request via user input to the GUI; identifying a first software module from a plurality of software modules, based on the cloud account update request; and transmitting a signal to the first software module based on the cloud account update request, the signal comprising information to perform the cloud account update.

### CROSS-REFERENCE TO RELATED APPLICATION(S)

This application claims priority to U.S. Provisional Application No. 63/171,158 filed Apr. 6, 2021, the entire disclosure of which is hereby incorporated herein by reference in its entirety.

### TECHNICAL FIELD

Various embodiments of the present disclosure relate generally to management of cloud assets, and more particularly, to methods and systems for providing a single command and control unit for managing a plurality of cloud assets across multiple cloud service providers.

### BACKGROUND

A single entity may utilize a plurality of cloud assets across multiple cloud service providers. These cloud assets may be managed using systems and tools provided by each respective cloud service provider such that a given cloud asset is managed using the respective system and tools of the cloud service provider associated with the given cloud asset. Such a distributed structure may lend to duplication of efforts in managing the plurality of cloud assets and may segregate the management of the cloud assets across various different systems and tools. The distributed structure may also lead to inefficiencies in the control of the plurality of cloud assets.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for managing a plurality of cloud assets across multiple cloud service providers.

In one aspect, a method for multi-cloud service provider operation is disclosed. The method may include: receiving first cloud account data from a first cloud service provider; receiving second cloud account data from a second cloud service provider; receiving analyzed content from a first software vendor and a second software vendor, the analyzed content based on the first cloud account data and the second cloud account data; correlating the first account data, the second account data, and the analyzed content; generating a correlated data graphical user interface (GUI) based on the correlating; receiving a cloud account update request via user input to the GUI; identifying a first software module from a plurality of software modules, based on the cloud account update request; and transmitting a signal to the first software module based on the cloud account update request, the signal comprising information to perform the cloud account update.

In another aspect, a system for multi-cloud service provider operation is disclosed. The system can include a memory configured to store instructions; and a processor operatively connected to the memory and configured to execute the instructions to perform a process for multi-cloud service provider operation. The process can include: receiving first cloud account data from a first cloud service provider; receiving second cloud account data from a second cloud service provider; receiving analyzed content from a first software vendor and a second software vendor, the analyzed content based on the first cloud account data and the second cloud account data; correlating the first account data, the second account data, and the analyzed content; generating a correlated data graphical user interface (GUI) based on the correlating; receiving a cloud account update request via user input to the GUI; identifying a first software module from a plurality of software modules, based on the cloud account update request; and transmitting a signal to the first software module based on the cloud account update request, the signal comprising information to perform a cloud account update.

In a further aspect, a computer-implemented method for multi-cloud service provider operation is disclosed. The computer-implemented method can include: retrieving one or more user account credentials for one or more accounts with a first cloud service provider; transmitting the one or more user account credentials to the first cloud service provider; receiving first cloud account data from the first cloud service provider; retrieving one or more user account credentials for one or more accounts with a second cloud service provider; transmitting the one or more user account credentials to the second cloud service provider; receiving second cloud account data from the second cloud service provider; receiving analyzed content from a software vendor, the analyzed content based on the first cloud account data and the second cloud account data; generating a correlated data graphical user interface (GUI) based on a correlation of the first account data, the second account data, and the analyzed content; receiving, via the correlated GUI, a request for an update to at least one of the first cloud account data and the second cloud account data; identifying a software module, based on the request; and transmitting a signal to the software module based on the request, the signal comprising information to perform the requested update.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for managing a plurality of cloud assets, according to one or more embodiments.

FIG. 2 depicts a flowchart of an exemplary method of managing a plurality of cloud assets across multiple cloud service providers, according to one or more embodiments.

FIG. 3 depicts a representation of an exemplary implementation of a system for managing a plurality of cloud assets, according to one or more embodiments.

FIG. 4 depicts a flowchart of an exemplary method of updating a plurality of cloud assets across multiple cloud service providers, according to one or more embodiments.

FIG. 5 depicts an example training module to train one or more of the machine learning models, according to one or more embodiments.

FIG. 6 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, article, or apparatus that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

As used herein, a “cloud service provider” may be a provider that enables an entity to create, host, launch, or otherwise activate one or more cloud accounts and provides cloud resources to use the one or more cloud accounts. Examples of cloud service providers include, but are not limited to, Amazon Web Services® (AWS®), Google Cloud®, Microsoft Azure®, and the like. A cloud service provider may provide cloud services in addition to activating cloud accounts. The cloud services may allow an entity to manage user accounts within the cloud service provider's ecosystem. An entity using multiple cloud service providers may manage cloud accounts associated with a first cloud service provider via the first cloud service provider's management platform and may manage cloud accounts associated with a second cloud service provider via the second cloud service provider's management platform.

As used herein, a “cloud account” may be an account that can perform one or more tasks via communication with and through an exchange of data from a remote system. The remote system may include one or more of a database, server, storage, and the like. The cloud account may have access to dedicated or non-dedicated remote storage space and may also have access to one or more processors for performing computing functions to act as a remote data center. Cloud storage associated with a cloud account may include stashing data in a remote physical location, which can be accessed from any device via the internet. A client device used to access a cloud account may send files to a data server maintained by a cloud service provider. A given entity may have a plurality of cloud accounts via one or more cloud service providers. Using a cloud account may mitigate security risks associated with local data storage and improve access to data from multiple locations. Use of one or more cloud accounts may enable an entity to conduct operations in service environments (e.g., software as a service, platform as a service, infrastructure as a service, etc.).

As used herein, a “software vendor” (also known as an “independent software vendor” or “ISV”) may be a vendor that integrates with a cloud service provider and provides a service to, or based on, the cloud service provider. Example software vendors may provide provisioning of auto-generated accounts (e.g., creating cloud accounts via a cloud service provider on an as needed basis), conducting compliance checks, implementing financial controls, managing digital workflows for enterprise operation, cloud management, cloud implementation, and/or the like. Software vendors may provide services to individual cloud service providers.

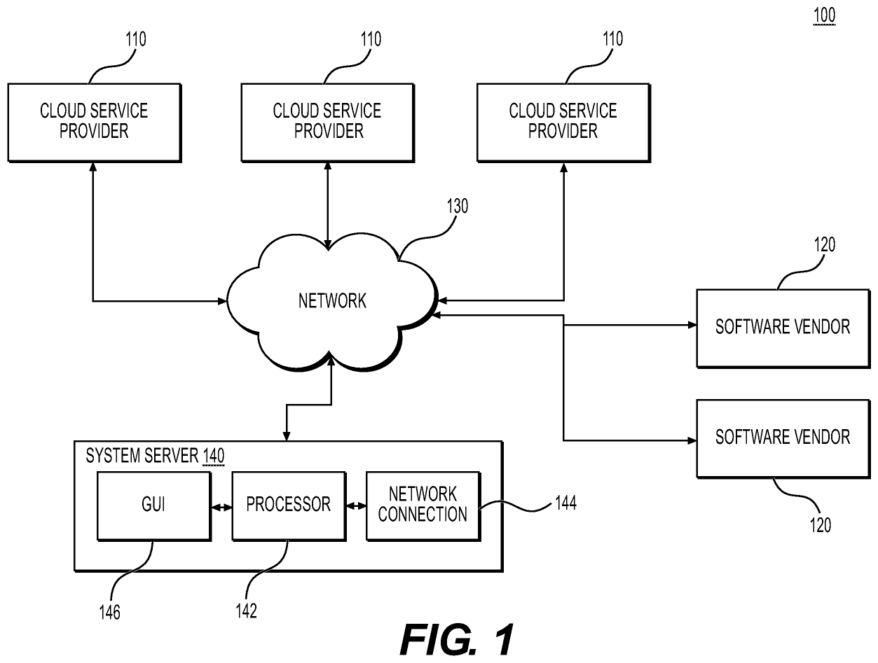

FIG. 1 depicts an exemplary cloud computing environment 100 that may be utilized with techniques presented herein. In some embodiments, the cloud computing environment 100 may be, may include, and/or may form a portion of a secure multi-cloud capability system. Cloud computing environment 100 includes cloud service providers 110 and software vendors 120 in communication with system server 140 via network 130. In some embodiments, multiple user accounts may be associated with the one or more of cloud service providers 110. The one or more software vendors 120 may connect system server 140 to one or more cloud service providers 110 via electronic network 130 instead of or in addition to a direct connection via network 130 between cloud service providers 110 and system server 140.

System server 140 can include processor 142, network connection 144, and graphical user interface (GUI) 146. Network connection 144 can allow system server 140 to communicate with other elements in the environment 100, such as one or more of cloud service providers 110 and/or software vendors 120. Processor 142 may be a single processor or multiple processors configured to aid in the management of a plurality of cloud assets across multiple cloud service providers 110. Processor 142 can also generate GUI 146, in order to provide and receive user inputs and feedback. Although multiple users may access the same or different instances of GUI 146, the disclosure provided herein generally references one user for simplicity.

In various embodiments, electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, electronic network 130 includes or is in communication with a telecommunications network, e.g., a cellular network.

Although depicted as separate components in FIG. 1, it should be understood that a component or portion of a component may, in some embodiments, be integrated with or incorporated into one or more other components. For example, software vendors 120 may be separate entities, or may share common resources. Further, it should be understood that data described as stored on a memory of a particular system or hardware in some embodiments, may be stored in another memory or distributed over a plurality of memories (e.g., cloud storage components) of one or more systems and/or devices in other embodiments. Additionally, or alternatively, some or all of the components of FIG. 1 may be part of the same entity that may receive data from one or more components (e.g., system server 140 via electronic network 130) and may transmit data to one or more components. The entity may physically house these components in the same or different locations or may access these components via a cloud-based connection or cloud server (e.g., via electronic network 130).

In the implementations described herein, various acts are described as performed or executed by components from FIG. 1. However, it should be understood that in various implementations, various components of computing environment 100 discussed above may execute instructions or perform acts including the acts discussed herein and that any act attributed to a particular component herein need not necessarily be performed by that particular component. Further, it should be understood that in various implementations, one or more steps may be added, omitted, and/or rearranged in any suitable manner.

According to implementations of the disclosed subject matter, GUI 146 may be cross-vendor management platform that functions as a “single pane of glass” or “single command and control unit” for managing a plurality (e.g., thousands and/or millions) of cloud assets across multiple cloud service providers 110. The multiple cloud service providers 110 may be hyper-scale cloud service providers and may include an architectural ability to scale appropriately as increased demand is added to the system. GUI 146 may be part of or may help implement aspects of a cloud adoption framework, as further disclosed herein. System server 140 may also be implemented as a plug-and-play architecture that enables an entity to associate inputs of a workflow with different outputs from another workflow, to create varied applications. For example, system server 140, via GUI 146, may provide cross cloud service provider management from a single platform to provide increased efficiency, holistic analysis, and streamlined workflows. GUI 146 may provide for management of all or a plurality of a user's cloud service providers and/or software vendors via a single sign-on.

GUI 146 may be an entity level tool, a department level tool, and/or an individual level tool. An entity level tool may be accessed by one or more users associated with an entity such that GUI 146 has an entity level configuration that remains the same for all users from the same entity. A department level tool may allow multiple instances of GUI 146 such that each instance may be associated with different settings or configurations and/or may have access to different sub-modules within GUI 146. An individual level tool may provide each individual who accesses GUI 146 their own instance of GUI 146, such that each instance may be tailored to an individual's settings, requirements, and/or access parameters.

System server 140 may be connected to the one or more cloud service providers 110 through one or more respective application programming interfaces (APIs). By using respective APIs, system server 140 may patch into the one or more cloud service providers and transmit and/or receive data, signals, instructions, or the like. Based on its connections with the one or more cloud service providers, GUI 146 may provide a cross platform overview of some or all of the cloud service providers associated with an entity. GUI 146 may also facilitate modification of one or more functionalities associated with cloud accounts across multiple different cloud service providers such as privacy, security, load management, data integrity, and system monitoring settings and configurations.

System server 140 may also be connected to the one or more software vendors 120 through one or more respective application programming interfaces (APIs). A software vendor 120 may itself be connected to a single cloud service provider 110 or may be connected to multiple cloud service providers 110. In some circumstances, if connected to multiple cloud service providers 110, a software vendor 120 may run multiple instances of its platform such that each cloud service provider is services by a different instance of a software vendor. By using respective APIs, system server 140 may patch into the one or more software vendors 120 and transmit and/or receive data, signals, instructions, or the like. Based on its connections with the one or more cloud service providers, GUI 146 may provide a cross platform overview of all the software vendors servicing the cloud service providers associated with an entity.

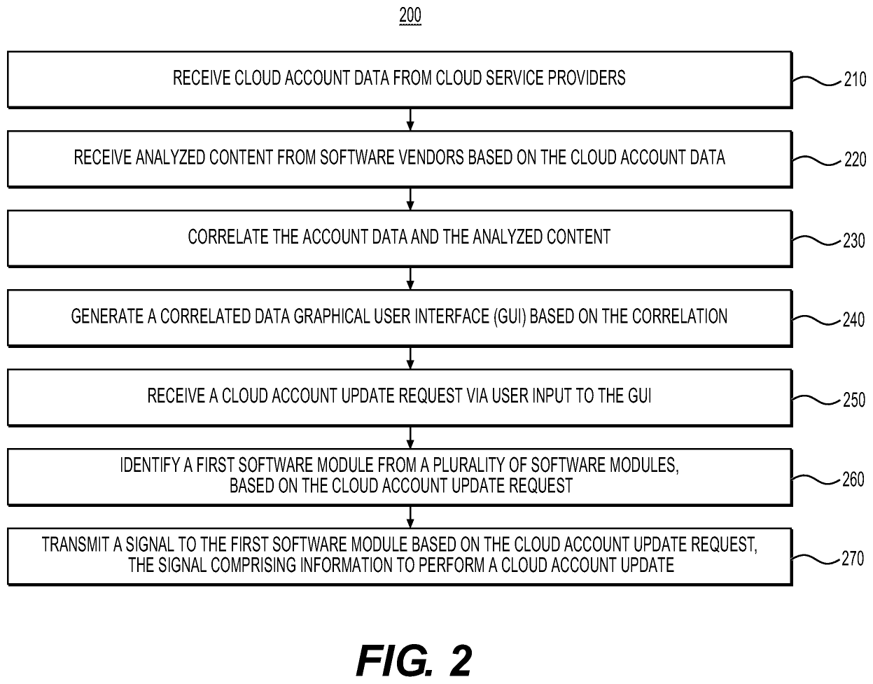

FIG. 2 shows an example method 200 for optimizing resources in accordance with the subject matter disclosed herein. At 210, system server 140 may receive cloud account data from two or more cloud service providers 110. For example, receiving the cloud account data may involve retrieving one or more user account credentials for one or more accounts with the first and second cloud service providers 110; and transmitting the one or more user account credentials to the respective cloud service provider. The cloud account data may be from one or more one cloud accounts provisioned with two or more of the cloud service providers 110. At 220, system server 140 may receive access to software vendors 120 associated with one or more of the cloud service providers 110, and the software vendors 120 may provide analyzed content to system server 140 based at least in part on data (e.g., cloud account data) from one or more of the cloud accounts of the user. The software vendors 120 may service the one or more cloud service providers 110 individually such that a given software vendor 120 may service a given cloud service provider 110 separately from servicing a different cloud service provider 110.

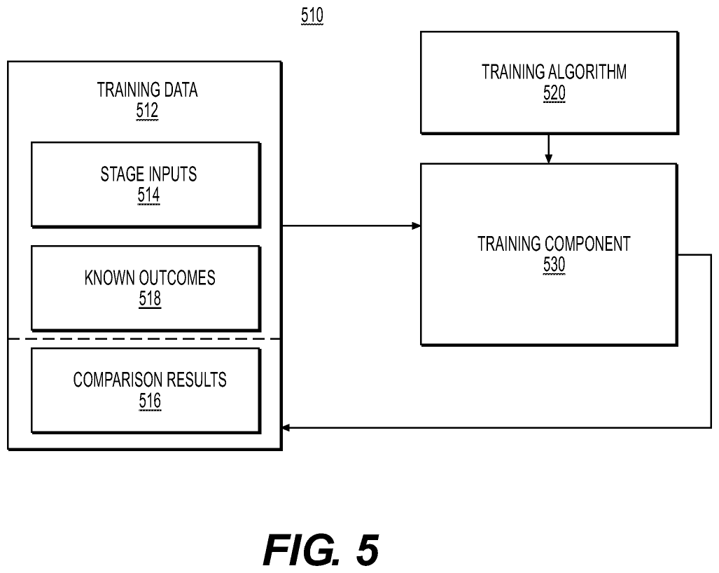

At 230, system server 140 can correlate the account data from the two or more cloud service providers 110 with the analyzed content provided by the one or more software vendors 120. In some embodiments, this correlation may be performed by or assisted by using a correlation machine learning model. Implementations of such a model are discussed in further detail below with respect to FIG. 5. The correlation machine learning model may be trained to identify, based on its weights, biases, layers, and/or the like, relationships between the account data and the analyzed content. The relationships may be identified based on correlation scores, probabilities, or the like, as determined by the correlation machine learning model. For example, correlation machine learning model may receive, as inputs, the account data from the two or more cloud service providers 110 and the analyzed content provided by the one or more software vendors 120. The correlation machine learning model may be configured to associated instances of the account data with instances of the analyzed content. The correlation machine learning model may output the correlated data and content.

Once the data and content are correlated, at 240, system server 140 can generate GUI 146 based on the correlation between the account data and the content from the software vendors 120. For example, GUI 146 can display information related to the first account data, the second account data, and the analyzed content simultaneously, and elements of GUI 146 can be generated and/or organized based on the correlation of the first account data, the second account data, and the analyzed content, as well as based on the contents of that data. GUI 146 can also include an operating status of the first and second cloud service providers, to allow a user to view the status of multiple cloud accounts and cloud service providers in a single interface.

At 250, and in response to displaying or otherwise providing one or more aspects of GUI 146 to a user, system server 140 can receive, via GUI 146, a request to update one or more parameters of one or more of the cloud accounts from which the cloud account data was collected. For example, such a request can include multiple requests pertaining to one or more accounts with the first cloud service provider and one or more accounts with the second cloud service provider.

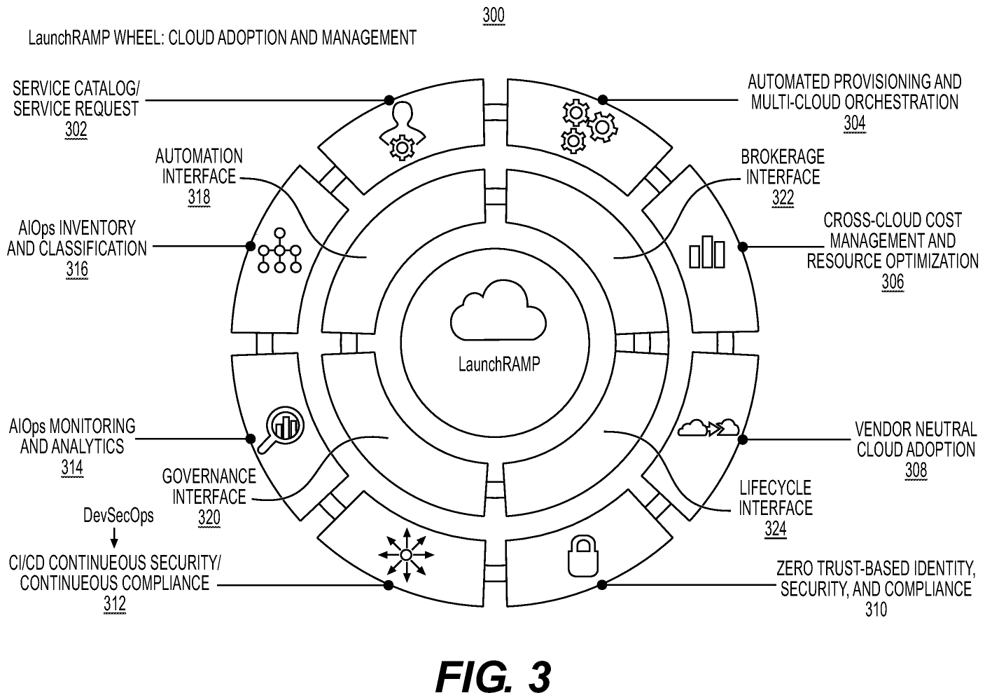

In order to execute the requested update, at 260, system server 140 may identify an appropriate software module among a plurality of software modules. The appropriate software module to effect the requested cloud account update may be based on one or more aspects of the cloud account update request such as the cloud account or accounts to be updated, the cloud service provider on which the cloud account resides, the type of update requested, or any other aspect of the cloud account update request that bears on the appropriate method of carrying out the requested cloud account update. According to an implementation, a requested cloud account update may require updating two or more different cloud accounts associated with respective two or more different cloud service providers. Having identified the module, at 270, system server 140 can transmit a signal, including information to perform the requested cloud account update, to the identified software module. Implementations of such signals generated and/or transmitted by system server 140 are further disclosed herein (e.g., in reference to FIG. 3). In some embodiments, the signal to the first software module can include information relevant to the performance of a cloud account update on at least one of the one or more accounts with the first cloud service provider and at least one of the one or more accounts with the second cloud service provider. The signal may include instructions to one or more of the cloud service providers 110 and/or one or more of the software vendors 120, and the first software module may be configured to parse those instructions and provide information to the cloud service providers 110 and/or the software vendors 120 as appropriate. The plurality of software modules may include, for example, modules related to one or more of governance, security, data provisioning, or financial management, from which an appropriate first software module may be identified and/or selected.

FIG. 3 shows an example implementation of GUI 146. System server 140 may provide GUI 146, which enables monitoring and control of multiple cloud service providers, cloud accounts, and respective functionalities. A user may be able to access the interface and select a monitoring or control activity to further address a corresponding functionality. As shown in FIG. 3, a management module may provide and/or facilitate service requests/service catalogs 302, multi-cloud orchestration and automated provisioning 304 (e.g., sample service catalog and end to end automated provisioning), cross-cloud cost management and resource optimization 306, vendor neutral cloud adoption 308, zero trust-based identity, security, compliance 310, developer security operations (DevSecOps) and continuous integration and continuous delivery (CI/CD) continuous security/continuous compliance 312, artificial intelligence operations (AIOps) monitoring and analytics 314, AIOps inventory and classification 316, multi-cloud identity and access management (IAM) and governance, application portability and interoperability, predictive multi-cloud operation management, cross-domain multi-cloud data security, integration with proprietary services, and the like.

A service catalog 302 may be accessed via GUI 146 and a user may be able to place a service request using service catalog 302. Service catalog 302 may be accessed using system server 140 (e.g., via GUI 146) via a sub-interface. The services provided via service catalog 302 may be cloud service provider agnostic and/or software vendor agnostic. For example, an entity may be able to select a service from service catalog 302 accessed via system server 140. Selection of a specific service from service catalog 302 may instruct each of a plurality of cloud service providers to activate the service at each of the cloud service providers. The instruction may be provided using respective APIs for each cloud service provider. As another example, the selected service may be a software vendor specific service. Accordingly, upon selection of the service, an instruction may be provided to the software vendor to apply the service to data received from each or a subset of the cloud service providers that are associated with the software vendor. Accordingly, management module 105 may allow selection and/or requests for services across multiple cloud service providers and/or service providers using a single central platform. Additionally, even if a given service is specific to a single cloud service provider or a single software vendor, that service may be requested via GUI 146 without a user having to directly access a separate control tool for that single cloud service provider or a single software vendor.

Service catalog 302 may be a cloud special item number (SIN) based service catalog and may facilitate automated provisioning 304. Service catalog 302 may integrate with one or more products to provide continuous security and compliance for all cloud accounts, cost management and optimization for all cloud accounts, governance and centralized role based account access (RBAC) access for all cloud accounts, multi-cloud application portability capabilities, multi-cloud security capabilities, and may provide multi-cloud application interoperability capabilities.

System server 140 may enable multi-cloud orchestration and automated provisioning 304 with no intervention or minimal user intervention. Automated provisioning (e.g., self-service provisioning) via system server 140 may allow one or more of the cloud service providers and/or one or more of the software vendors to implement pre-defined procedures electronically, without user intervention in individual accounts and cloud service providers. The pre-defined procedures may be generated by an entity or user and may be applied to multiple cloud service providers or multiple software vendors using respective APIs connecting system server 140 to the respective multiple cloud service providers or multiple software vendors. System server 140 may implement automated provisioning 304 using a customized service catalog for all cloud service providers priced to the given entity's requirements. The catalog may include pricing for chargeback/showback events and may facilitate automated end to end provisioning of organization compliant accounts, identities, and resources from a single interface. By using GUI 146 to provide cloud account update requests, a user or entity may reduce the time and resources required to implement multi-cloud orchestration by provisioning tasks at a single point.

System server 140 may facilitate cross-cloud cost management and resource optimization 306 based on information and data from each of a plurality of cloud service providers and/or software vendors. As discussed, system server 140 may have access (e.g., via respective APIs) to each of a plurality of cloud service providers and software vendors. Accordingly, the management module may implement a cost and resource optimization process based on information and data from the plurality of cloud service providers and software vendors to identify optimizations across the plurality of cloud service providers and software vendors. Based on the results of the cost and resource optimization process, resources may be reallocated across the plurality of cloud service providers and software vendors to optimize cost and/or resource use. It will be understood that such cross-cloud cost management and resource optimization 306 is possible due to the connection of the plurality of cloud service providers and software vendors to system server 140.

System server 140 may provide vendor neutral cloud adoption 308 based on the requirements identified by a given entity or user. GUI 146 may identify the requirements of a given entity or user based on a review of the current or anticipated cloud landscape (e.g., current cloud service providers, current software vendors, requirements, etc.) accessible to system server 140. Based on the current or anticipated cloud landscape, system server 140 may identify optimal cloud service provider resources and/or software vendor resources for a user or entity. Such holistic cloud adoption based on a current or anticipated may reduce costs and improve resource allocation.

System server 140 may also implement security and delivery protocols (e.g., zero trust-based identity, security, compliance 310; DevSecOps, CI/CD, continuous security/continuous compliance 312) across multiple cloud service providers based on security protocols centrally submitted via GUI 146. For example, a given entity may require upgrading security protocols for all its cloud service providers and/or software vendors to a higher security level. System server 140 may enable the entity to centrally push the higher security level out to all cloud service providers and/or software vendors instead having to individually update the security level at each individual cloud service provider and/or software vendor. Respective cloud service provider and/or software vendor APIs may be used by system server 140 to code such security updates and/or other tasks disclosed herein. According to implementations, system server 140 may facilitate enforcement of continuous authorization to operate (ATO) through continuous security and continuous compliance across all cloud accounts (i.e., including all cloud accounts across multiple cloud service providers) via a single interface, in real-time. System server 140 may also allow proactive auto-remediation of critical and high security threats which may be identified based on the cross-cloud access implemented by system server 140. GUI 146 may also provide comprehensive visibility and management of organization cloud security posture and risk exposure across all accounts (i.e., including all cloud accounts across multiple cloud service providers) by correlating and visualizing cloud account data.

System server 140 may enable artificial intelligence (AI) based operations (e.g., AIOps monitoring and analytics 314; AIOps inventory and classification 316). One or more AI models may be provided to system server 140 and may be trained to control the plurality of cloud service providers and/or software vendors based on cross-cloud data and information. For example, system server 140 may provide a resource allocation AI model with real-time data regarding the performance of each cloud service provider associated with an entity. The resource allocation AI model may detect a downtrend in a given cloud service provider's performance which may indicate a potential fault in the respect cloud service provider's availability. Accordingly, the resource allocation AI model may activate backup or alterative cloud accounts that do not rely on the given cloud service provider until the downtrend is resolved. Such Al based control may occur based on user or entity provided rules or may be independent of any user or entity input. By applying data and information from multiple cloud service providers and/or multiple software vendors, an AI model may holistically evaluate and improve operations of a multi-cloud based entity.

According to an implementation, system server 140 may include a plurality of sub-interfaces accessible via GUI 146. The sub-interfaces may correspond to system server 140 capabilities such that each sub-interface and/or dashboard, as further disclosed herein, corresponds to a system server 140 capability. The sub-interfaces may include, for example, automation interface 318, brokerage interface 322, lifecycle interface 324, and governance interface 320. Automation interface 318 may provide access to automation tools including, but not limited to, tools for multi-cloud orchestration and automated provisioning 304, AIOps inventory and classification 316, AIOps monitoring and analytics 314, and the like. Brokerage interface 322 may provide access to intermediaries such as API related tools for communication with one or more cloud service providers and/or software vendors. Lifecycle interface 324 may provide an overview of existing operations from start to finish and/or may provide outstanding tasks to complete an overall operation. Governance interface 320 may provide the ability to replicate organization hierarchy and enforce security and budget policies through inheritance. It may also facilitate implementation of consistent gold image standard enforcement across all clouds. Governance interface 320 may provide ease of access to all cloud accounts using a single interface controlled by RBAC implementations, and may also provide enforcement of an organization security baseline at account creation based on given standards (e.g., standard based on templates). Governance interface 320 may also provide project level budget management and control and enforce budget thresholds. It may also provide alerts at account creation and/or implementation based on exceeding thresholds or other criteria.

Additional interfaces that may be accessible via GUI 146 include a cost management dashboard, operations or service dashboard, security dashboard, asset dashboard, privacy dashboard, data integrity dashboard or the like. The cost management dashboard may be independent or may be integrated with governance interface 320 and may monitor all cloud service provider costs associated with an entity. It may be used to provide or implement thresholds, security, and/or cost based rules. The operations dashboard may be used to monitor activity via all cloud service providers and may receive input from one or more AI modules to control the operation of one or more resources associated with the cloud service providers. The operations dashboard may also provide an overview of all cloud accounts across multiple cloud service providers and may also show current software vendors and their respective associations with the multiple cloud service providers. A security dashboard may be independent or may be integrated with governance interface 320 and may be used to monitor all cloud service provider security features. It will be understood that although a plurality of different interfaces and/or dashboards are listed herein, some or all of the interfaces and/or dashboards may be combined to provide the same or similar functionality. It will also be understood that although dashboards and interfaces are disclosed separately herein, the terms “dashboard” and “interface” may be used interchangeably or one may correspond to dedicated graphical areas whereas the other may correspond to a different output (e.g., an overlay). An architecture decision tool for just in time architecture (JITA) may also be provided and may include a display (e.g., a screen) for architecture selection. The architecture decision tool may be used to compare various cloud services for optimization or implementation.

According to an implementation, an entity may use system server 140 and the governance capability to provide a single interface to provision cloud accounts in a standard manner with centralized RBAC access, organizational security baseline, and alerts, access, and privacy settings enforced at the time of creation. According to another implementation, system server 140, GUI 146, service catalog 302, and automated provisioning 304 capabilities may be used to provide a single interface to provision resources in a standard format using approved automation templates, machine images (MIs), pricing (e.g., infrared and labor), and/or workflow approvals, to provision cloud resources across multiple cloud providers. According to another implementation, the management module and continuous security and compliance capabilities may be used to implement continuous security and compliance for all cloud accounts with auto-remediation using a single platform to ensure cloud environments continue to be compliant with security standards (e.g., security standards established at account creation). According to another implementation, system server 140 and continuous cost management and optimization capabilities may be used for cost management across all cloud accounts with cost optimization recommendations, using a single platform to ensure cloud environments are cost optimized and do not exceed budget.

According to an implementation, system server 140 may generate security flags (e.g., via governance interface 320 and/or security dashboard) upon identification of security, data, or privacy breaches by one or more cloud accounts, cloud service providers, or software vendors. System server 140 may identify security breaches on an individual level (i.e., at the one or more cloud accounts, cloud service providers, or software vendors, etc.) or may generate security flags based on cross-cloud breaches. For example, system server 140 may identify a security threat based on a first cloud account via a cloud service provider having code that provides access to a second cloud account via a second cloud service provider without requiring security credentialing. Such a cross-cloud breach would not be identified at an individual level and, thus, system server 140 provides a degree of security higher than the degree of security at an individual level. System server 140 may also identify cloud behavior patterns (e.g., using a health or skill rating system) for accounts based on their security status. Subject areas for issues or risks may be identified by a machine learning model which may also detect patterns of issues and may also predict future issues prior to their occurrence.

According to an implementation, system server 140 may generate and provide statistics for a plurality of cloud service providers. The statistics may include performance statistic, security compliance statistics, and the like and may be generated based on information and data gathered by system server 140 from each of the plurality of vendors. The statistics may be provided to one or more machine learning models to improve the performance, security compliance, etc., based on the statistics. The machine learning model may shift creation of cloud accounts to cloud service providers most optimally suited to implement the tasks associated with the respective cloud accounts, optimizing the overall multi-cloud system.

According to an implementation, as shown in FIG. 1, system server 140 may receive data generated at first and second software vendors 120. First software vendor 120 may be in communication with a first cloud service provider 110 and may service cloud accounts associated with that provider, while second software vendor 120 may be in communication with a second cloud service provider 110 and may service cloud accounts associated with the second provider. For a number of reasons (e.g., security and/or governance-related reasons), an output by the first software vendor 120 may be segregated from data output by second software vendor 120. System server 140 may receive data output by both software vendors 120 and may provide a user or an entity with analysis based at least in part on both first and second cloud service providers 110. This analysis may combine the data to provide a user or entity with a holistic multi-cloud understanding of its operations.

According to an implementation, an adoption framework may be used to implement or improve an entity's cloud platform. For an entity without a cloud platform, the adoption framework may facilitate ground-up implementation of one or more cloud service providers, creation of cloud accounts, implementation of cloud services, or the like. For an entity with an existing cloud platform, the adoption framework may facilitate improvement and/or modernization of the existing cloud platform. The adoption framework may be used to determine how to migrate existing platforms to a cloud platform, how to procure cloud accounts, how to automate cloud based procedures, how to secure the cloud platform, how to implement AI to optimize the cloud platform, or the like, or a combination thereof.

System server 140 may be used to implement the adoption framework. A user or entity may access GUI 146 to implement multiple steps of the adoption framework, over a time period, such that multiple cloud service providers, multiple user accounts, and/or multiple software vendors are on-boarded using system server 140. System server 140 may select an optimal architecture for the cloud platform based on criteria including, but not limited to, cloud readiness assessments, maturity of development operation (DevOps), security assessments, existing architecture maturity, and the like. System server 140 may track the progress of adoption framework and provide a user or entity with a holistic view of the progress of the cloud platform implementation. For example, the multi-cloud orchestration and automated provisioning 304 interface accessed via GUI 146 may be used to provision new cloud accounts with a cloud service provider most suitable to the tasks required from respective new cloud accounts.

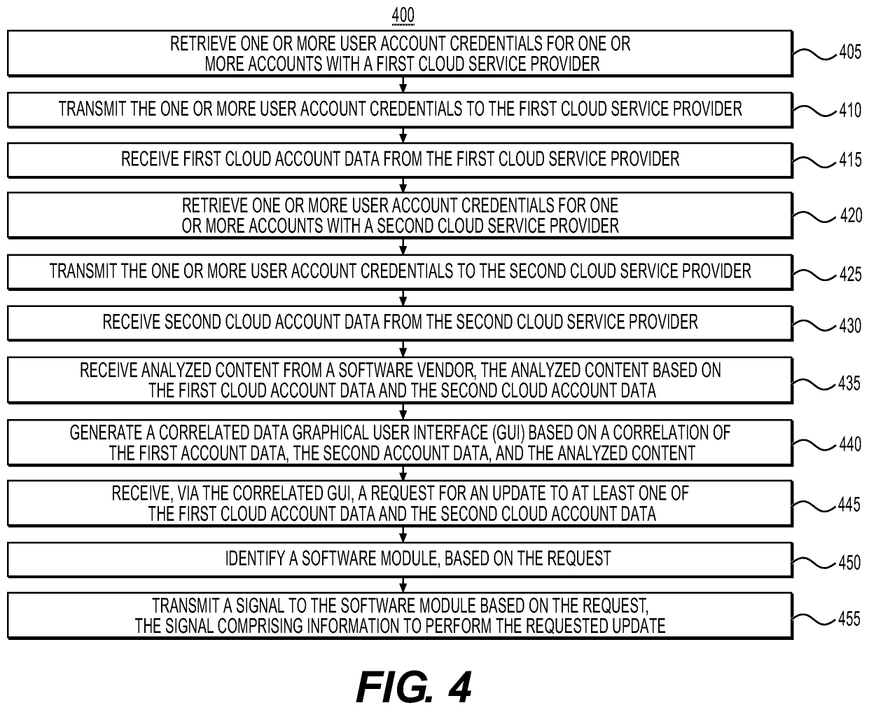

FIG. 4 shows an example method 400 for optimizing resources in accordance with the subject matter disclosed herein. At 405, system server 140 can retrieve one or more user account credentials for one or more accounts with a first cloud service provider. At 410, system server may then transmit the one or more user account credentials to the first cloud service provider. In response to this transmission, at 415, system server 140 may receive first cloud account data from the first cloud service provider.

For multi-cloud account/multi cloud service provider applications, at 420, system server 140 may retrieve one or more user account credentials for one or more accounts with a second cloud service provider. Similar to the above discussion, at 425, system server may transmit the one or more user account credentials to the second cloud service provider, and, at 430, system server may receive second cloud account data from the second cloud service provider.

At 435, system server may also receive analyzed content from a software vendor, based on the software vendor's analysis of the first cloud account data and the second cloud account data. At 440, based on a correlation of the first account data, the second account data, and the analyzed content, system server 140 may generate a correlated data GUI 146. This GUI 146 may then be displayed or otherwise provided to one or more users and/or entities.

The users and/or entities may desire to modify one or more aspects of the cloud environment, and as a result, at 445, system server 140 may receive a request for an update to at least one of the first cloud account data and the second cloud account data via GUI 146. At 450, based on the request, system server 140 can identify a software module, and at 455, system server 140 can transmit a signal to the software module based on the request. The transmitted signal may comprise the information needed to perform the requested update. Upon completion of the cloud account update, GUI 146 can then be refreshed to reflect the new changes.

As disclosed herein, one or more components of the disclosed subject matter may be implemented using one or more machine learning or artificial intelligence models. FIG. 5 shows an example training module 510 to train one or more of the machine learning models disclosed herein. It will be understood that a different training module may be used to train each of the machine learning models disclosed herein and/or single training module 510 may be used to train two or more machine learning models.

As shown in FIG. 5, training data 512 may include one or more of stage inputs 514 and known outcomes 518 related to a machine learning model to be trained. Stage inputs 514 may be from any applicable source including capabilities of system server 140, an output from a stage (e.g., one or more outputs from a stage from method 200 of FIG. 2 or method 400 of FIG. 4), or the like. Known outcomes 518 may be included if the machine learning model is generated based on supervised or semi-supervised training. An unsupervised machine learning model may not be trained using known outcomes 518. Known outcomes 518 may include known or desired outputs for future inputs similar to or in the same category as stage inputs 514 that do not have corresponding known outputs.

Training data 512 and training algorithm 520 may be provided to training component 530 that may apply training data 512 to training algorithm 520 to generate a machine learning model. According to an implementation, training component 530 may be provided comparison results 516 that compare a previous output of the corresponding machine learning model to apply the previous result to re-train the machine learning model. Comparison results 516 may be used by training component 530 to update the corresponding machine learning model. Training algorithm 520 may utilize machine learning networks and/or models including, but not limited to a deep learning network.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the methods illustrated in FIGS. 2 and 4, may be performed by one or more processors of a computer system, such any of the systems or components in the computing environment of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or components in FIG. 1. One or more processors of a computer system may be included in a single computing device or distributed among a plurality of computing devices. One or more processors of a computer system may be connected to a data storage device. A memory of the computer system may include the respective memory of each computing device of the plurality of computing devices.

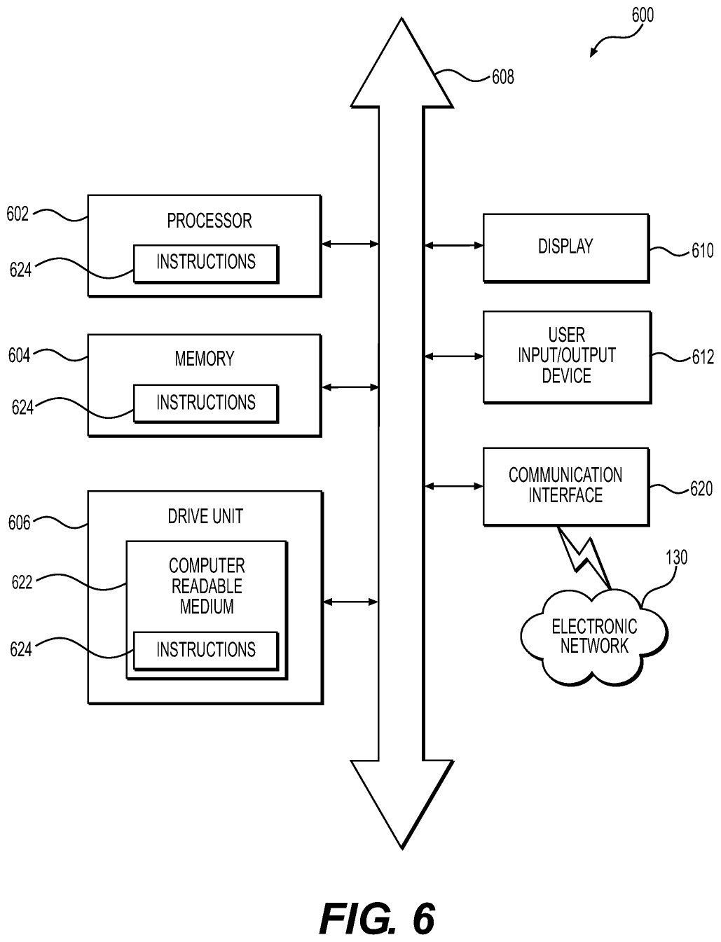

FIG. 6 is a simplified functional block diagram of computer system 600 that may be configured as a device for executing the methods of FIGS. 2 and/or 4, according to exemplary embodiments of the present disclosure. FIG. 6 is a simplified functional block diagram of a computer system that may generate interfaces and/or another system according to exemplary embodiments of the present disclosure. In various embodiments, any of the systems (e.g., computer system 600) herein may be an assembly of hardware including, for example, data communication interface 620 for packet data communication. Computer system 600 also may include central processing unit (“CPU”) 602, in the form of one or more processors, for executing program instructions. The computer system 600 may include an internal communication bus 608, and storage drive unit 606 (such as ROM, HDD, SDD, etc.) that may store data on computer readable medium 622, although the computer system 600 may receive programming and data via network communications. Computer system 600 may also have memory 604 (such as RAM) storing instructions 624 for executing techniques presented herein, although the instructions 624 may be stored temporarily or permanently within other modules of computer system 600 (e.g., processor 602 and/or computer readable medium 622). Computer system 600 also may include input and output ports 612 and/or display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Aspects of the technology disclosed herein may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, a mobile device, a wearable device, an application, or the like (e.g., that is used to access and/or operate system server 140). Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for multi-cloud service provider operation, the method comprising:
receiving first cloud account data from a first cloud service provider;
receiving second cloud account data from a second cloud service provider;
receiving analyzed content from a first software vendor and a second software vendor, the analyzed content based on the first cloud account data and the second cloud account data;
correlating the first account data, the second account data, and the analyzed content;
generating a correlated data graphical user interface (GUI) based on the correlating;
receiving a cloud account update request via user input to the GUI;
identifying a first software module from a plurality of software modules, based on the cloud account update request; and
transmitting a signal to the first software module based on the cloud account update request, the signal comprising information to perform the cloud account update.

2. The method of claim 1, wherein receiving first cloud account data includes:
retrieving one or more user account credentials for one or more accounts with the first cloud service provider; and
transmitting the one or more user account credentials to the first cloud service provider.

3. The method of claim 2, wherein receiving second cloud account data includes:
retrieving one or more user account credentials for one or more accounts with the second cloud service provider; and
transmitting the one or more user account credentials to the second cloud service provider.

4. The method of claim 1, wherein correlating the first account data, the second account data, and the analyzed content includes using a correlation machine learning model.

5. The method of claim 1, wherein the correlated data GUI displays information related to the first account data, the second account data, and the analyzed content simultaneously and wherein components of the GUI are organized based on the correlating the first account data, the second account data, and the analyzed content.

6. The method of claim 5, wherein the correlated data GUI includes an operating status of the first and second cloud service providers.

7. The method of claim 1, wherein the cloud account update request includes a request pertaining to one or more accounts with the first cloud service provider and one or more accounts with the second cloud service provider.

8. The method of claim 7, wherein the signal to the first software module includes information to perform a cloud account update on at least one of the one or more accounts with the first cloud service provider and at least one of the one or more accounts with the second cloud service provider.

9. The method of claim 1, wherein the first software module from the plurality of software modules is a module related to one or more of governance, security, data provisioning, or financial management.

10. A system, comprising:
a memory configured to store instructions; and
a processor operatively connected to the memory and configured to execute the instructions to perform a process for multi-cloud service provider operation, including:
receiving first cloud account data from a first cloud service provider;
receiving second cloud account data from a second cloud service provider;
receiving analyzed content from a first software vendor and a second software vendor, the analyzed content based on the first cloud account data and the second cloud account data;
correlating the first account data, the second account data, and the analyzed content;
generating a correlated data graphical user interface (GUI) based on the correlating;
receiving a cloud account update request via user input to the GUI;
identifying a first software module from a plurality of software modules, based on the cloud account update request; and
transmitting a signal to the first software module based on the cloud account update request, the signal comprising information to perform a cloud account update.

11. The system of claim 10, wherein receiving first cloud account data includes:
retrieving one or more user account credentials for one or more accounts with the first cloud service provider; and
transmitting the one or more user account credentials to the first cloud service provider.

12. The system of claim 11, wherein receiving second cloud account data includes:
retrieving one or more user account credentials for one or more accounts with the second cloud service provider; and
transmitting the one or more user account credentials to the second cloud service provider.

13. The system of claim 10, wherein correlating the first account data, the second account data, and the analyzed content includes using a correlation machine learning model.

14. The system of claim 10, wherein the correlated data GUI displays information related to the first account data, the second account data, and the analyzed content simultaneously and wherein components of the GUI are organized based on the correlating the first account data, the second account data, and the analyzed content.

15. The system of claim 14, wherein the correlated data GUI includes an operating status of the first and second cloud service providers.

16. The system of claim 10, wherein the cloud account update request includes a request pertaining to one or more accounts with the first cloud service provider and one or more accounts with the second cloud service provider.

17. The system of claim 16, wherein the signal to the first software module includes information to perform a cloud account update on at least one of the one or more accounts with the first cloud service provider and at least one of the one or more accounts with the second cloud service provider.

18. The system of claim 10, wherein the first software module from the plurality of software modules is a module related to one or more of governance, security, data provisioning, or cost management.

19. A computer-implemented method for multi-cloud service provider operation, the computer-implemented method comprising:
retrieving one or more user account credentials for one or more accounts with a first cloud service provider;
transmitting the one or more user account credentials to the first cloud service provider;
receiving first cloud account data from the first cloud service provider;
retrieving one or more user account credentials for one or more accounts with a second cloud service provider;
transmitting the one or more user account credentials to the second cloud service provider;
receiving second cloud account data from the second cloud service provider;
receiving analyzed content from a software vendor, the analyzed content based on the first cloud account data and the second cloud account data;
generating a correlated data graphical user interface (GUI) based on a correlation of the first account data, the second account data, and the analyzed content;
receiving, via the correlated GUI, a request for an update to at least one of the first cloud account data and the second cloud account data;
identifying a software module, based on the request; and
transmitting a signal to the software module based on the request, the signal comprising information to perform the requested update.

20. The computer-implemented method of claim 19, wherein the correlation of the first account data, the second account data, and the analyzed content is performed using a correlation machine learning model.
